(19) United States
(12) Patent Application Publication
(10) Pub. No.: US 2026/0199170 A1
(43) Pub. Date: Jul. 16, 2026

(54) Hamstring Stretching Device

(71) Applicants: Andrew Ryan, Cambridge, MA (US); Alaina Ryan, Los Angeles, CA (US)

(72) Inventors: Andrew Ryan, Cambridge, MA (US); Alaina Ryan, Los Angeles, CA (US)

(21) Appl. No.: 19/446,450

(22) Filed: Jan. 12, 2026

Related U.S. Application Data
(60) Provisional application No. 63/745,199, filed on Jan. 14, 2025.

(51) Int. Cl. A61H 1/02

(52) U.S. Cl. CPC A61H 1/0266; A61H 2201/0192; A61H 2201/1253; A61H 2201/1623; A61H 2201/164; A61H 2203/0437

(57) ABSTRACT

An exercise apparatus for stretching hamstrings includes a back rest to support the spine and a foot panel movably coupled to the back rest. The foot panel is positioned such that a user sits with slightly bent knees. By pressing into the foot panel, the user actively engages the muscles the legs while the back remains supported, allowing controlled hamstring stretching without lumbar strain. Variations include sliding mechanical guides or adjustable strap connections of the back rest to the foot panel.

### CROSS-REFERENCE TO RELATED APPLICATIONS

This application claims priority to U.S. Provisional Patent Application No. 63/745,199, filed January 14, 2025, titled “Exercise Device”, the contents of which are hereby incorporated by reference in their entirety.

### FIELD OF THE INVENTION

The invention relates generally to exercise equipment, and more specifically to a device for safely stretching hamstrings of a user.

### BACKGROUND ART

Tight hamstrings are a common issue that may contribute to lower back pain, hip pain, sciatic nerve pain, and other discomforts. Traditional hamstring stretching often requires spinal flexion or unsupported forward bending that can aggravate injuries, strain lumbar muscles, or worsen spinal pathology. Users recovering from back injury often cannot safely perform conventional stretches.

Existing devices such as seated stretchers and strap-based systems do not provide adjustable rigid back support while enabling active quadriceps engagement to lengthen hamstrings under controlled conditions.

There is a need for a device that permits supported, safe, incremental hamstring stretching by stabilizing the spine and pelvis while enabling the user to actively extend the legs forward under load

### SUMMARY OF THE INVENTION

The invention provides an exercise device configured to stretch hamstrings while maintaining spinal alignment. The act of stretching the hamstrings may alleviate back pain, sciatica pain and general pain in the legs, hips, and back. In one aspect of the disclosure, an exercise device to enable stretching of hamstrings is disclosed. The exercise device includes a back rest arranged to provide support to a back of the user during stretching. The exercise device also includes a foot panel defining a vertically extending surface to support feet of the user during stretching. The foot panel is movably coupled to the back rest to position the foot panel at a desired distance from the back rest. Typically, the desired distance corresponds to a distance at which legs/knees of the user are bent when the user sits between the back rest and the foot panel with feet resting on the foot panel and back supported on the back rest. The back rest and the foot panel are generally fixed at a predefined distance while the exercise device is in use, and both the back rest and the foot panel are structurally sufficient to bear the necessary loads applied by the user. This allows the user to apply quadriceps contraction of the user to stretch the hamstring.

In some embodiments, adjustable straps may replace a generally rigid frame to connect the foot panel and back rest. The straps are sufficient to bear the loads applied by the user. Additionally, the straps allow the distance between the back rest and the foot panel to adjust to the user’s desired length.

### BRIEF DESCRIPTION OF THE DRAWINGS

Embodiments of the present invention are illustrated by way of examples and are not limited to the accompanying drawings:

FIG. 1 shows a side perspective view of an exercise device, in accordance with an embodiment of the present invention;

FIG. 2 shows a front perspective view of the exercise device of FIG. 1, in accordance with an embodiment of the present invention; and

FIG. 3 shows a side perspective view of the exercise device of FIG. 1 having a back rest and having a foot panel arranged at a desired position and depicting feet of a user resting on the foot panel and leg/knees arranged in bent position pushing against the foot panel, in accordance with an embodiment of the present invention;

FIG. 4 shows a side perspective view of the exercise device of FIG. 1 having a back rest and having a foot panel arranged at a desired position and depicting feet of a user resting on the foot panel and the user exerting a force on the panel to stretch the hamstrings, in accordance with an embodiment of the present invention; and

FIG. 5 shows a side perspective view of an alternative embodiment of exercise device having a back rest and having a foot panel arranged at a desired position and depicting feet of a user resting on the foot panel and the user exerting a force on the panel to stretch the hamstrings, in accordance with an embodiment of the present invention.

### DETAILED DESCRIPTION OF INVENTION

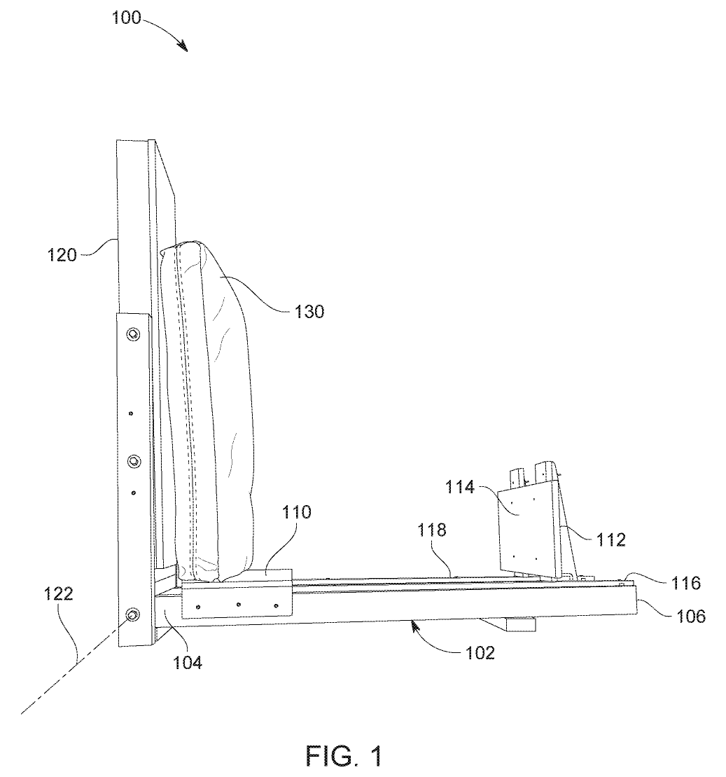

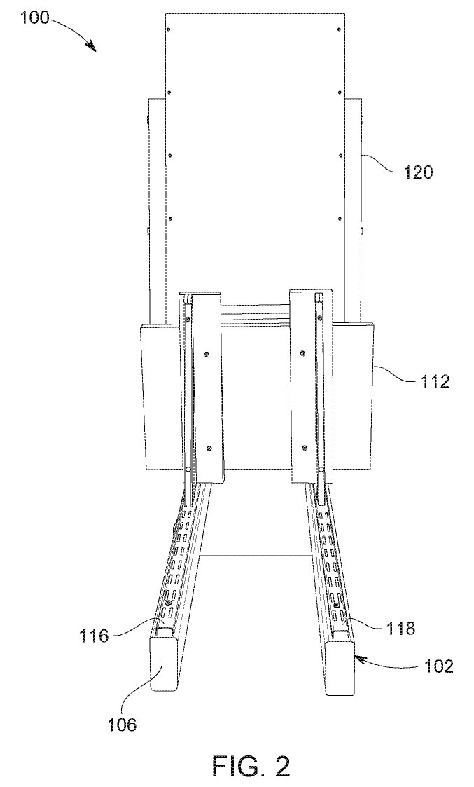

Referring to FIGS. 1 to 4, an exercise or stretching device 100 suitable to stretch hamstrings to alleviate pain in the hamstrings, back, and/or hip of the user. As shown, the device 100 includes a base 102 having a first end 104 and a second end 106, a back rest 120 coupled to the base 102, a seat 110 attached to the base 102 and arranged supported a user on the base 102, and a foot panel 112 adjustably mounted to the base 102. The seat 110 is arranged proximate to the first end 104 of the base 102 and facilitates a seating of the user on the device 100 to perform stretching exercise. The foot panel 112 extends in a vertical direction from the base 102 and provides a vertically extending surface 114 for position of feet of the user to perform the exercise. The foot panel 112 is arranged to slide along a length of the base 102 between a plurality of mounting positions to adjust a distance of the foot panel 112 from the back rest 120. To facilitate sliding of the foot panel 112 along the length of the base 102, and mounting of the foot panel 112 at any desired mounting position out of the plurality of mounting positions, the base 102 includes a pair of rails 116, 118 extending along the length of the base 102 and arranged spaced apart from each other in a lateral direction. After arranging the foot panel 112 at the desired position, the foot panel 112 is non-movably mounted to the base 102 i.e., the rails 116, 118 by using suitable mounting structures. For example, pins structures may be extended through the aligned holes of the foot panel 112 and the rails 116, 118 or the base 102 to non-movably mount the foot panel 112 on the base 102 at the desired mounting position. It may be envisioned that the mounting position of the foot panel 112 depends upon a length of the legs of the user. The rails 116, 118 may be any structure that allows for adjustment of the foot panel to be secured at a desired position.

Further referring to FIG. 1, the device 100 includes the back rest 120 to support a back of the user. In an embodiment of the invention, the back rest 120 is configured to maintain the user’s lumbar spine in a substantially neutral position during application of force to the foot panel. The back rest 120 is arranged at the first end 104 of the base 102 and extends substantially, vertically upwardly from the base 102 . Accordingly, the foot panel 112 and the back rest 120 are arranged spaced apart and are disposed facing each other. The seat 110 is arranged proximate to the back rest 120 and is disposed between the foot panel 112 and the back rest 120. In some embodiments, the back rest 120 is fixedly attached to the base 102 and extends substantially perpendicularly to the base 102. In some embodiments, the back rest 120 is pivotally attached to the base 102 and is arranged to pivot between a first position and a second position about a pivot axis 122. In the first position, the back rest 120 is arranged substantially perpendicularly to the base 102, as shown in FIGS. 1 to 4, while in the second position, the back rest 120 is arranged tilted towards the foot panel 112, and is disposed at an acute angle relative to the base 102. It may be appreciated that the back rest 120 may be arranged at one or more intermediate positions between the first position and the second position to adjust/arranged the back rest at a desired inclination relative to the base 102. Additionally, the device 100 includes a back pad/cushion 130 adapted to be positioned between the back rest 120 and the back of the user while performing exercise. The back pad/cushion 130 is a compressible pad and is adapted to compress underloading during exercise. In another embodiment, the back rest is constructed of a compressible material or elastic material such that the distance between the back rest and the foot panel will lengthen when a user exerts pressure against the foot panel.

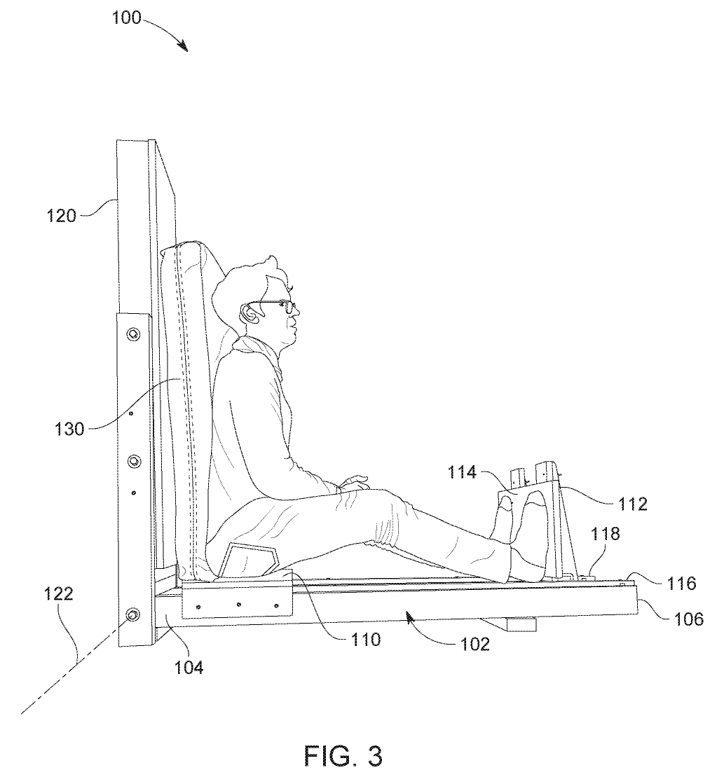

The device 100 should be structurally sufficient to bear the necessary loads applied by the user during exercise. The back rest 120 and the foot panel 112 should be constructed with sufficient strength to generally maintain the position and orientation desired by the user such that the user may apply one’s strength to stretch the hamstring as shown in FIG. 3. In an embodiment of the invention, the distance between the foot panel and the back rest remains substantially fixed during hamstring stretching.

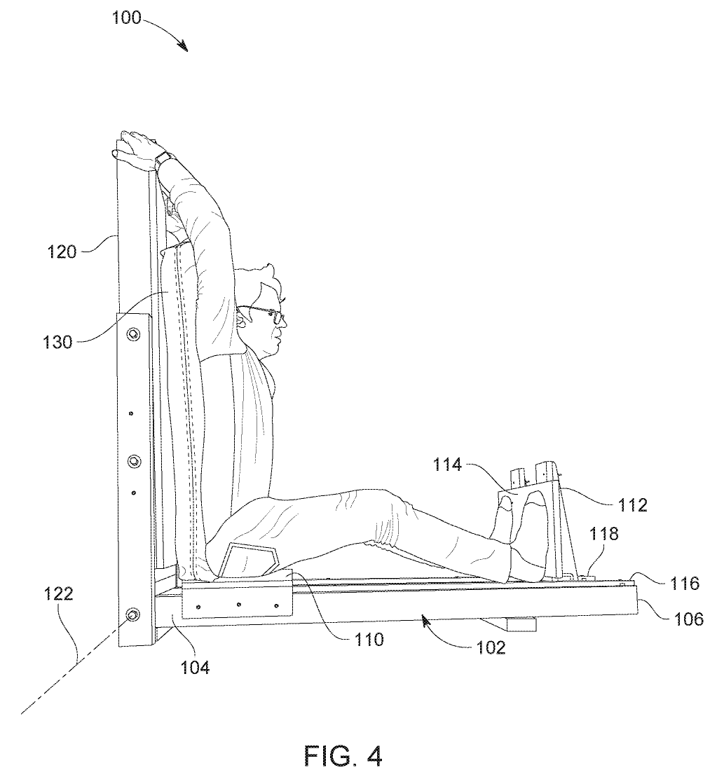

A method of performing the exercise is now described. For stretching the hamstring and relieving pain, the user arranges the foot panel 112 to a mounting position such that the legs/knees are arranged slightly bent when the user sits on the seat 110 with the back resting against the pad 130 of the back rest 120 and feet arranged on surface 114 of the foot panel 112. Upon mounting the foot panel 112 at such mounting position, the user sits on the seat 110 with feet arranged on the surface 114 of the foot panel 112, as shown in FIG. 3. Thereafter, the user begins to press on into the feet. As the quads of the user engage, the legs slowly begin to straighten, causing limited posterior pelvic translation against the back pad while maintaining lumbar alignment 130, compressing the back pad 130 and supporting the spine and back of the user in a proper position. As the user continues to push the feet on the foot panel 112, the legs stretch, causing stretch in the hamstrings, calves, glutes, and lower back. The user may grab the top of the back rest 120 to elongate the upper body and reinforce good posture, as shown in FIG. 4. Over time, as the user gets more flexible, the user may adjust the angle of the back rest 120 relative to the base 102 so that the user is now entering a supported forward fold.

In another embodiment of the invention, the seat 110 is omitted and the user sits on the same support surface that the base rests 102 upon. In such an embodiment, the user arranges the foot panel 112 to a mounting position such that the legs/knees are arranged slightly bent when the user sits with their back resting against the pad 130 of the back rest 120 and feet arranged on surface 114 of the foot panel 112. Upon mounting the foot panel 112 at such mounting position, the user sits on the support surface with feet arranged on the surface 114 of the foot panel 112. The embodiment may or may not include a back pad 130.

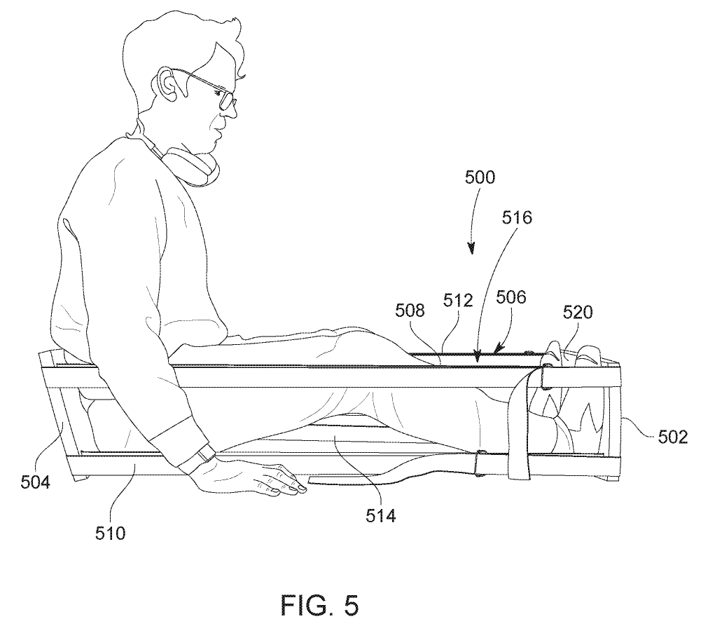

Referring to FIG. 5, an exercise device 500 is shown, according to another example embodiment. The exercise device 500 includes a foot panel 502, a back rest 504, and a connecting structure 506 connecting the foot panel 502 and the back rest 504. The connecting structure 506 includes at least one strap arranged in a loop shape and connecting the foot panel 502 and the back rest 504. The connecting structure 506 replaces the rails 116, 118 to locate the back rest 504 at a distance relative to the foot panel 502 when the device is in use. In an embodiment, the connecting structure 506 includes four straps 508, 510, 512, 514 with two straps 508, 510 extending between first lateral ends of the foot panel 502 and the back rest 504, and other two straps 512, 514 extending between second lateral ends of the foot panel 502 and the back rest 504. Also, the user is positioned within a space 516 defined between the straps 508, 510 connecting the first lateral ends and the straps 512, 514 connecting the second lateral ends of the foot panel 502 and the back rest 504. In the embodiments, the length of the straps 508, 510, 512, 514 may be adjusted to adjust a distance between the foot panel 502 and the back rest 504 either enlarging or reducing the space 516 for the user. The distance between the foot panel 502 and the back rest 504 is selected such that the legs are slightly bent when with user is inside the space 516 with the back resting against the back rest 504 and feet arranged on the vertically extending surface 520 of the foot panel 502, and the straps 508, 510, 512, 514 fully/completely extended/taut. After positioning a user in such manner, the user begins to engage the legs pressing the feet against the foot panel 502. As the quad engage, the legs slowly begin to straighten, causing the hip to push back the back rest 504 . Due to continuous pushing the feet on the foot panel 502, the legs stretch, causing stretch in the hamstrings, calves, glutes, and lower back.

The straps 508, 510, 512, 514 may be constructed from any substantially rigid material such that when the user engages the muscles of the legs and back, the straps 508, 510, 512, 514 maintain the desired distance between the foot panel 502 and the back rest 504. Similarly, the length of the straps 508, 510, 512, 514 may be adjusted using any common adjustment method such that when the user engages the muscles of the legs and back, the straps 508, 510, 512, 514 maintain the desired distance between the foot panel 502 and the back rest 504. In one embodiment, the straps 508, 510, 512, 514 are substantially inelastic to maintain a fixed distance between the foot panel 502 and the back rest 504.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Many modifications and other implementations of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims.

What is claimed is:

1. An exercise device for stretching hamstrings of a user comprising:
a back rest configured to support a back of the user;
a foot panel defining a vertically oriented foot-engagement surface; and
an adjustable coupling between the foot panel and the back rest configured to position the foot panel at a selected distance from the back rest such that when the user is seated between the back rest and the foot panel, the user’s knees are bent; and
wherein the back rest and adjustable coupling are structured to resist and absorb force generated as the user applies pressure against the foot panel such that hamstring lengthening is produced while the user’s spine remains supported by the back rest.

2. The device of claim 1, wherein the distance between the foot panel and the back rest remains substantially fixed during hamstring stretching.

3. The device of claim 1, wherein the back rest is configured to maintain the user’s lumbar spine in a substantially neutral position during application of force to the foot panel.

4. The device of claim 1 wherein the back rest is coupled to a base.

5. The device of claim 1 wherein the back rest further comprises a pad.

6. The device of claim 1, wherein the back rest and the foot panel are coupled to a base having laterally spaced rails, and the distance between the back rest and the foot panel is slidably adjustable along the rails on the base.

7. The device of claim 1, wherein the back rest is pivotally mounted to a base to permit the back rest to vary inclination.

8. The device of claim 1, wherein the adjustable coupling comprises straps connecting the foot panel to the back rest.

9. The device of claim 8, wherein the straps are configured to remain substantially inelastic under loads sufficient to induce hamstring stretching.

10. The device of claim 6, wherein the rails comprise multiple mounting positions for securing the foot panel.

11. The device of claim 1, wherein the back rest comprises foam, elastomer, spring mechanism, or shock-absorbing material.

12. A method of stretching hamstrings, comprising:
seating a user against a back rest;
positioning a foot panel at a distance from the back rest such that the user’s knees are bent;
placing feet against the foot panel; and
applying force through the feet by actively extending the knees to engage the legs against the foot panel while the back remains supported by the back rest.

13. The method of claim 12, wherein the back rest further comprises a pad.

14. The method of claim 12, wherein the back rest and the foot panel are coupled to a base having laterally spaced rails, and the distance between the back rest and the foot panel is slidably adjustable along the rails on the base.

15. An exercise device for stretching hamstrings of a user comprising:
a base having a rail;
a back rest coupled to the base configured to support a back of the user;
a foot panel defining a vertically oriented foot-engagement surface slidably coupled to the rail at a selected distance from the back rest such that when the user is seated between the back rest and the foot panel, the user’s knees are bent; and
wherein the distance between the foot panel and the back rest remains substantially fixed during hamstring stretching while the user’s spine remains supported by the back rest.

16. The device of claim 15, wherein the rail comprises multiple mounting positions for securing the foot panel.

17. The device of claim 15, wherein the base includes a seat to support the user on the rail.
